(19) United States
(12) Patent Application Publication
(10) Pub. No.: US 2013/0068112 A1
(43) Pub. Date: Mar. 21, 2013

(54) PORTABLE ELECTRIC POTATO STRIPS BAKING DEVICE

(71) Applicant: Wei-Teh HO, Taipei City (TW)

(72) Inventor: Wei-Teh HO, Taipei City (TW)

(21) Appl. No.: 13/236,598

(22) Filed: Sep. 19, 2011

(51) Int. Cl. A21B 5/00

(52) U.S. Cl. 99/352

(57) ABSTRACT

A portable electric potato strips baking device includes a main body, a heating chamber, a cylindrical portion, a tubular heating portion and a control chamber. The heating chamber is disposed inside the main body and provides the space for the baking of potato strips. The cylindrical portion is disposed inside the heating chamber and can rotate. In use, potato strips are placed inside the cylindrical portion. The tubular heating portion is disposed on the outside of the cylindrical portion and is used to cook the potato strips placed inside the cylindrical portion. A positioning plate may be rotated to adjust the orientation of the tubular heating portion. The control chamber is disposed inside the heating chamber and has a motor, which drives the cylindrical portion and hence allows potato strips to be baked evenly.

### BACKGROUND OF THE INVENTION

1. Field of the Invention

The invention generally relates to a potato strips baking device. More particularly, the invention relates to a portable electric potato strips baking device, which is easy to carry, powered by electricity and specifically designed for the baking of potato strips.

2. Description of the Prior Art

In the modern life, life pace becomes faster and faster. To save time, people spend lesser time in their meals; therefore, fast food becomes quite popular. The most basic type of fast food is potato strips or fries and such type of fast food is sold by most of fast food shops.

To save time in cooking, most of potato strips are fried and then are ready to serve. Because either potato or yam is basically carbohydrate or starch, they absorb a large amount of oil or grease in the frying process and hence they become quite crispy and taste good. However, because they contain a large amount of oil or grease, they are quite greasy and unhealthy and many people try to avoid such type of food.

Some people use baking to cook potato strips to reduce its grease content. However, in the traditional frying or baking process, large-size cookware is needed. Because of the higher cost in the traditional frying or baking process, potato strips are often cooked in volume and such cooking processes are quite unfriendly to the environment since a lot of waste or garbage is generated. Therefore, the traditional frying or baking process is not suitable to be used for homes; instead, they are suitable for fast food shops due to the higher cooking cost.

When a person wants to have some potato strips for a snack, fries sold by a fast food ship are obviously not a good choice. However, he can not cook them by himself because he does not have a baking device. Therefore, he often has no choice but to buy some fries from a fast food shop and then swallows a lot of grease and empty calories.

The inventor has put a lot of effort into the subject and has successfully come up with the portable electric potato strips baking device of the present invention. The baking device of the present invention is easy to use and carry and is compact. In addition, the baking device is environmentally friendly and meets the simple cooking need in homes or other places.

### SUMMARY OF THE INVENTION

An object of the present invention is to provide a portable electric potato strips baking device, which is easy to use and may be used to bake potato strips any time.

Another object of the present invention is to provide a portable electric potato strips baking device, which is light, compact and easy to carry around so that such device may be use in homes or other places.

A third object of the present invention is to provide a portable electric potato strips baking device, which may be sealed by a cover, has a health-oriented design and may be used to cook wholesome food.

A fourth object of the present invention is to provide a portable electric potato strips baking device, which small bits of food are contained in the device and is environmentally friendly because no waste oil is generated.

To reach these objects, the portable electric potato strips baking device of the present invention is disclosed. The baking device of the present invention comprises a main body, a heating chamber, a cylindrical portion, a tubular heating portion and a control chamber. The heating chamber is disposed inside the main body and provides the space for the baking of potato strips. The cylindrical portion is disposed inside the heating chamber and can rotate. In use, potato strips are placed inside the cylindrical portion. The cylindrical portion has an opening. A cover is provided and may be opened to allow potato strips to be placed inside the cylindrical portion or to be taken out from there. The tubular heating portion is disposed on the outside of the cylindrical portion and is used to cook the potato strips placed inside the cylindrical portion. A positioning plate may be rotated to adjust the orientation of the tubular heating portion. The control chamber is disposed inside the heating chamber and has a motor, which drives the cylindrical portion and hence allows potato strips to be baked evenly.

### BRIEF DESCRIPTION OF THE DRAWINGS

The features and advantages of the present invention will be fully understood and appreciated from the following detailed description of the preferred embodiment and the accompanying drawings.

FIG. 1 is an exploded view of the portable electric potato strips baking device of the present invention.

FIG. 2 is a perspective view illustrating the baking device of the present invention in an assembled condition with the cover and the additional cover portion detached.

FIG. 3 is a perspective view illustrating the baking device of the present invention in an assembled condition with the cover and the additional cover portion attached.

### DETAILED DESCRIPTION OF THE PREFERRED EMBODIMENT

The structure, usage and features of the present invention will be fully understood and appreciated from the following detailed description of the preferred embodiment and the accompanying drawings.

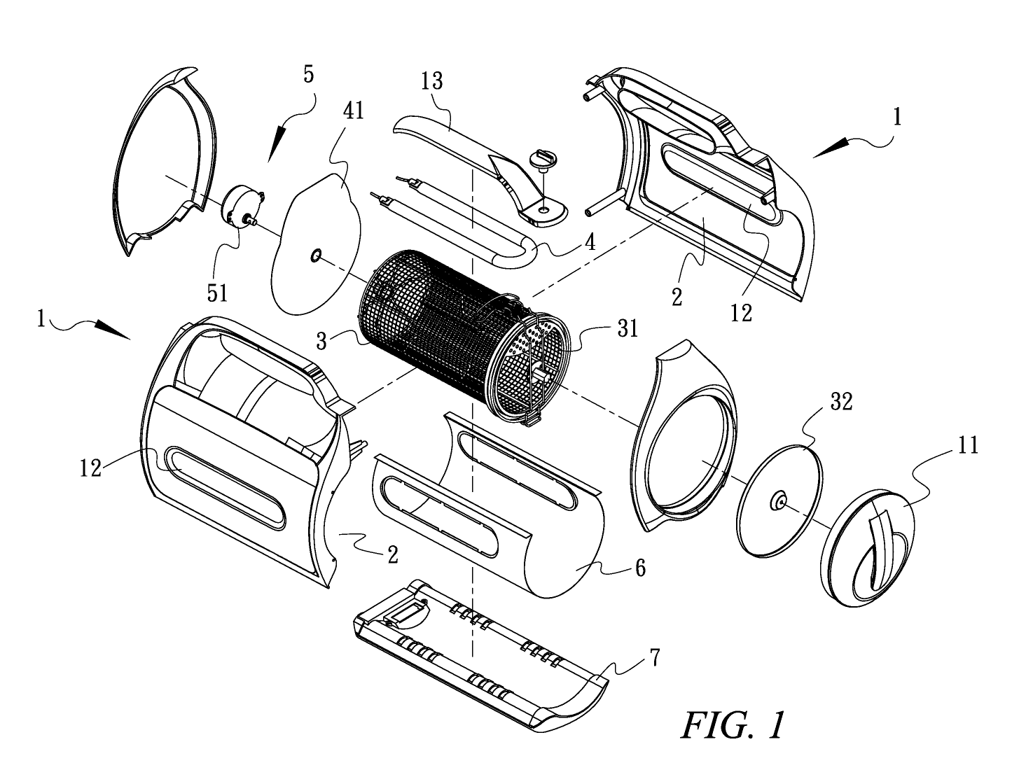

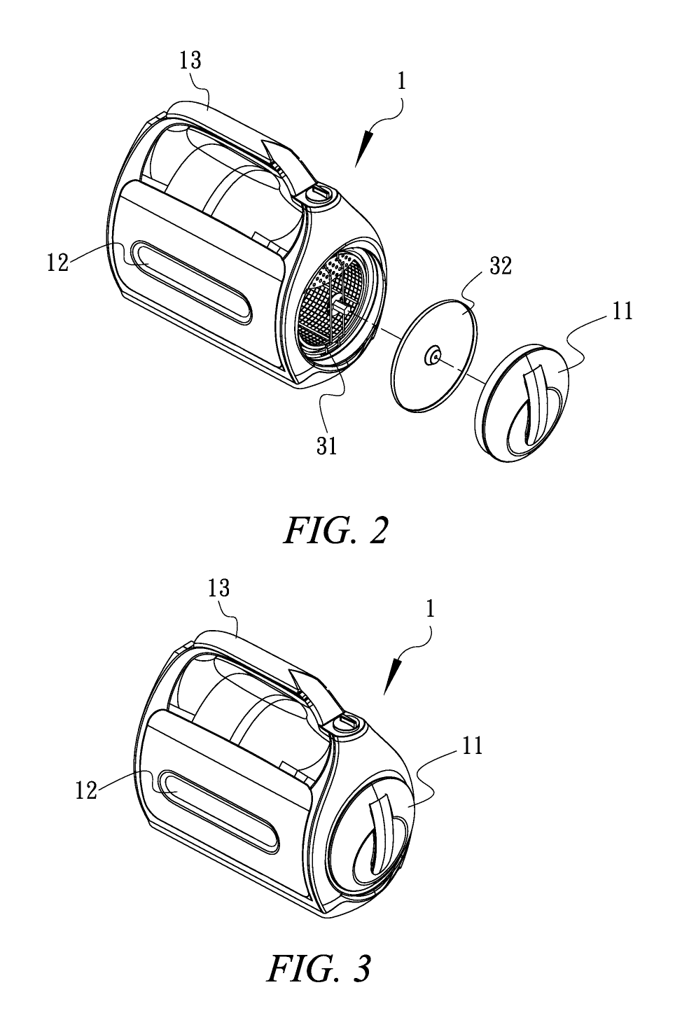

Please refer to FIGS. 1 to 3, which illustrate the portable electric potato strips baking device of the present invention. The baking device of the present invention comprises a main body 1, a heating chamber 2, a cylindrical portion 3, a tubular heating portion 4 and a control chamber 5.

The heating chamber 2 is disposed inside the main body 1 and provides the space for the baking of potato strips. The cylindrical portion 3 is disposed inside the heating chamber 2 and can rotate. In use, potato strips are placed inside the cylindrical portion 3. The cylindrical portion 3 has an opening 31. A cover 11 is provided and may be opened to allow potato strips to be placed inside the cylindrical portion 3 or to be taken out from there. The tubular heating portion 4 is disposed on the outside of the cylindrical portion 3 and is used to cook the potato strips placed inside the cylindrical portion 3. The control chamber 5 is disposed inside the heating chamber 2 and has a motor 51, which drives the cylindrical portion 3 and hence allows potato strips to be baked evenly.

In addition, the cylindrical portion 3 has a fishnet structure to facilitate the baking process. A protective portion 6 is circumferentially disposed around the outside of the heating chamber 2 so as to contain the small bits of potato strips and dusts therein. An additional cover portion 32 is provided and is disposed between the opening 31 and the cover 11 so as to seal the opening 31 so that potato strips will not accidentally fall out of the cylindrical portion 3 and then go into the main body 1.

Also, the tubular heating portion 4 is disposed on a positioning plate 41, which may be rotated to adjust the orientation of the tubular heating portion 4.

Moreover, a see-through window 12 is disposed on one side of the main body 1 to allow a user to see the cooking condition of the potato strips in the heating chamber 2. Optionally, such see-through window 12 may be disposed on both sides of the main body 1. A handle 13 is disposed on top of the main body 1 to allow a user to carry the baking device of the present invention around. In addition, a base portion 7 is disposed on the bottom of the main body 1 to carry the entire device.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable electric potato strips baking device, comprising:
a main body;
a heating chamber, disposed inside the main body and providing a space for baking of potato strips;
a cylindrical portion, disposed inside the heating chamber and able to rotate, and wherein, in use, the potato strips are placed inside the cylindrical portion, and the cylindrical portion has an opening which allows entry and exit of the potato strips;
a tubular heating portion, disposed on the outside of the cylindrical portion and used to cook the potato strips placed inside the cylindrical portion; and
a control chamber, disposed inside the heating chamber and has a motor, which drives the cylindrical portion and hence allows the potato strips to be baked evenly.

2. The portable electric potato strips baking device as in claim 1, wherein a see-through window is disposed on one side of the main body to allow a user to see cooking condition of the potato strips in the heating chamber.

3. The portable electric potato strips baking device as in claim 2, wherein two see-through windows are disposed on both sides of the main body, respectively.

4. The portable electric potato strips baking device as in claim 1, wherein a protective portion is circumferentially disposed around the outside of the heating chamber so as to contain small bits of the potato strips and dusts therein.

5. The portable electric potato strips baking device as in claim 1, wherein the cylindrical portion has a fishnet structure.

6. The portable electric potato strips baking device as in claim 1, wherein a cover is provided and may be opened to allow the potato strips to be placed inside the cylindrical portion or to be taken out from the cylindrical portion.

7. The portable electric potato strips baking device as in claim 6, wherein an additional cover portion is provided and is disposed between the opening and the cover so as to seal the opening so that the potato strips will not accidentally fall out of the cylindrical portion and then go into the main body.

8. The portable electric potato strips baking device as in claim 1, wherein the tubular heating portion is disposed on a positioning plate which may be rotated to adjust the orientation of the tubular heating portion.

9. The portable electric potato strips baking device as in claim 1, wherein a handle is disposed on top of the main body to allow a user to carry the baking device.
